(19) United States
(12) Patent Application Publication
(10) Pub. No.: US 2002/0121481 A1
(43) Pub. Date: Sep. 5, 2002

(54) Water treatment system

(75) Inventors: Paul Peterson, Cuyahoga Falls, OH (US); George Jordan, Chardon, OH (US); Stuart Park, Burton, OH (US); Christopher Hansen, Newbury, OH (US); Lisa Heiden, Chardon, OH (US)

Correspondence Address: WATTS, HOFFMANN, FISHER, & HEINKE CO., L.P.A., PO Box 99839, Cleveland, OH, 44199-0839, US

(73) Assignee: Kinetico Incorporated

(21) Appl. No.: 10/033,331

(22) Filed: Nov. 1, 2001

Related U.S. Application Data
(60) Provisional application No. 60/245,023, filed on Nov. 1, 2000.

(51) Int. Cl. B01D 15/00

(52) U.S. Cl. 210/673; 210/269

(57) ABSTRACT

A water treatment system including a pair of water treatment tanks, each tank defining a flow path extending from a tank inlet to a tank outlet and containing a water treatment material disposed along the flow path for removing sulfur or H2S from the water. A system controller controls the frequency of regeneration of an exhausted tank as well as the regeneration cycle. The system includes a regenerant reservoir containing 5.25% sodium hypochloride which is generally available as household bleach. During a regeneration cycle, the bleach is drawn through a restrictor preferably in the form of a capillary tube that forms part of a draw tube assembly.

### TECHNICAL FIELD

The present invention relates generally to fluid treatment and in particular to a water treatment system that removes sulfur from drinking water.

### BACKGROUND ART

There are many types of water treatment systems currently available for treating water in both residential and commercial applications. One type of treatment system is a water softener which typically includes a resin tank through which hard water passes to exchange its “hard” ions of calcium and magnesium for “soft” sodium ions from the resin bed. Regeneration of the resin bed is required periodically to remove the accumulation of hard ions and replenish the supply of soft ions. Regeneration is typically effected by flushing a brine solution through the resin bed. A water softener of this type is more fully described in U.S. Pat. No. 3,891,552 issued Jun. 24, 1975 to William Prior and James W. Kewley, entitled CONTROL VALVE FOR WATER SOFTENERS.

In the water softener disclosed in U.S. Pat. No. 3,891,552 a brine tank is utilized which includes a reservoir connected to a source of water and a supply of salt which together provide a brine solution to be used during regeneration.

Commercially available water softeners generally include one or two tanks which contain the softening chemicals that form the resin beds. In one type of two-tank water softener, one tank is regenerated and kept “off-line” while the other tank is “on-line.” A control valve controls the communication of the tanks with the household water supply and controls the timing and sequence of regeneration. An example of such a control valve is disclosed in U.S. Pat. No. 3,891,552. An improved control valve is described in U.S. Pat. No. 4,298,025. Both of these patents are owned by the present assignee and are herein incorporated by reference.

As indicated above, water softeners operate on an ion exchange principle and hence can only remove ions from water. In some parts of the country, “problem water” is encountered. The type of problem water to which this invention is directed is water that contains sulfur which is usually in the form of hydrogen sulfide. Water softeners generally cannot deal effectively with this type of water problem. Attempts have been made to remove sulfur from water using carbon filters. These types of filters can remove hydrogen sulfide but generally must be replaced frequently once a predetermined amount of sulfur has been captured. Attempts have been made to flush the captured sulfur from the filters using chlorine tablets or similar compounds such as the type used for swimming pools. It has been found, however, that the process for cleansing the sulfur from the carbon filter using chlorine is an exothermic reaction. If not controlled, relatively high temperatures can occur in the filter unit. In addition, by not carefully controlling the cleansing process, the carbon filter material can be damaged, substantially reducing its useful life.

### DISCLOSURE OF INVENTION

The present invention provides a new and improved method and apparatus for treating water containing an undesirable substance such as sulfur.

In accordance with the invention, the water treatment system includes at least one filter unit containing carbon, preferably catalytic carbon, which is periodically regenerated, a reservoir for regeneration solution which in the preferred embodiment is an oxidant solution of either normal household bleach (typically sodium hypochlorite in the range of 5.25%-6% by weight) or 6%-8% hydrogen peroxide, and a control apparatus for determining the frequency of regeneration as well as controlling the regeneration process itself. In the preferred and illustrated embodiment, a twin tank configuration is used. In the preferred configuration, during normal service, the filter tanks are arranged in a parallel flow relationship, i.e., both tanks filter source water concurrently thereby increasing the capacity (flow rate) of the system. This arrangement eliminates the possibility of stagnant water in the off-line tank, by constantly flowing water through both tanks. If only one tank is on-line in normal service, the off-line tank would sit for a period of time, thus, allowing for the possibility of the water in the off-line tank to grow bacteria or become stagnant. When a given tank requires regeneration in order to remove the trapped sulfur, it is taken off-line, regenerated and then immediately placed back on-line.

In the preferred and illustrated embodiment of the invention, the regeneration process includes several process steps. In the preferred process, a pre-backwash is performed first which rinses (in a reverse flow direction, also referred to as counterflow) the catalytic carbon bed with filtered water from the other tank. The pre-backwash fluffs the catalytic carbon by lifting and/or loosening the bed, in preparation for the regeneration or cleansing step. During the regeneration step, an oxidant solution is draw from the regenerant tank into the control valve. As the oxidant solution enters a venturi forming part of the control valve, it is diluted with filtered water, and then communicated to the tank requiring regeneration. The diluted oxidant solution is then passed through the catalytic carbon bed (in a reverse flow direction) and is discharged from the tank. Following the regeneration step, the catalytic carbon bed is then slowly rinsed in a reverse flow direction to allow for additional contact time. Alternatively, the drawing of oxidant solution and slow rinse can be done concurrently. Next the catalytic carbon bed is rinsed in a reverse direction at a higher flow rate sufficient to flush any remaining oxidant solution from the tank. In the preferred embodiment, as a final step, a down flow fast rinse is performed to recompact the bed and flush any remaining oxidant solution from the tank. Following regeneration, the regenerated tank is placed on line in parallel with the other tank.

According to a feature of the invention, the regenerant is an oxidant solution preferably household bleach which is readily available from many sources. Since very little bleach is needed in order to perform the regeneration step, a draw tube assembly is used which includes a flow restrictor to restrict the amount of bleach that is drawn into the tank being regenerated. In the preferred and illustrated embodiment, a capillary tube located at an inlet end of a draw tube assembly is utilized. A filter element at the very end of the draw tube inhibits particulate matter from entering and blocking the capillary tube. The draw tube assembly also includes a check valve to prevent the flow of water from the control valve into the regenerant tank. Unlike conventional brine-type systems, the regenerant i.e. bleach in the regenerant tank is not diluted at the conclusion of the regeneration cycle as is the case with brine systems. A check valve is located in the draw tube assembly to prevent the flow of water from the control valve into the regenerant reservoir. An overflow port is formed in the regenerant tank which is connected to drain and serves to convey fluid from the regenerant tank to drain in the event that a part of the draw tube assembly may allows leakage, which would otherwise cause the regenerant reservoir to overfill with water from the control module.

If the source water is hard (containing calcium and magnesium ions) and/or includes iron in either the ferric or ferrous form, then pretreatment of the feed water is recommended for optimum performance. In most cases a water softener will suffice in providing iron free and soft water.

The present invention provides a new and improved water treatment system which is capable of removing sulfur and/or hydrogen sulfide from water.

Additional features of the invention will become apparent and a fuller understanding obtained by reading the following detailed description made in connection with the accompanying drawings.

### BRIEF DESCRIPTION OF DRAWINGS

FIG. 1 is a schematic representation of a filter system for removing sulfur and hydrogen sulfide from source water, constructed in accordance with a preferred embodiment of the invention;

FIG. 2 is a side elevational view of a twin tank filter system, including a regenerant reservoir, constructed in accordance with a preferred embodiment of the invention;

FIG. 3 is a top plan view of the filter system as seen from a plane indicated by the line 3-3 in FIG. 2;

FIG. 4 is a sectional view of a tank as seen from the plane indicated by the line 4-4 in FIG. 2;

FIG. 5 is a sectional view of a regenerant reservoir constructed in accordance with the preferred embodiment of the invention;

FIG. 5A is a sectional view of an alternative regenerant reservoir for applications in harsh conditions

FIG. 6 is a sectional view of the regenerant reservoir as seen from the plane indicated by the line 6-6 in FIG. 5;

FIG. 6A is a sectional view of the alternate regenerant reservoir as seen from the plane indicated by the line 6A-6A in FIG. 5A;

FIG. 7 is an enlarged, fragmentary view of a lower end of the regenerant reservoir shown in FIG. 5;

FIG. 7A is an enlarged, fragmentary view of a lower end of the alternate regenerant reservoir shown in FIG. 5A;

FIGS. 8 and 9 are a perspective view of a regeneration control disk and an associated port insert, forming part of the present invention;

FIG. 10 is a fragmentary sectional view of an upper portion of a control valve which may be used with the present invention; and,

FIG. 11 is a fragmentary sectional view of a lower portion of a control valve which may be used with the present invention.

### BEST MODE FOR CARRYING OUT THE INVENTION

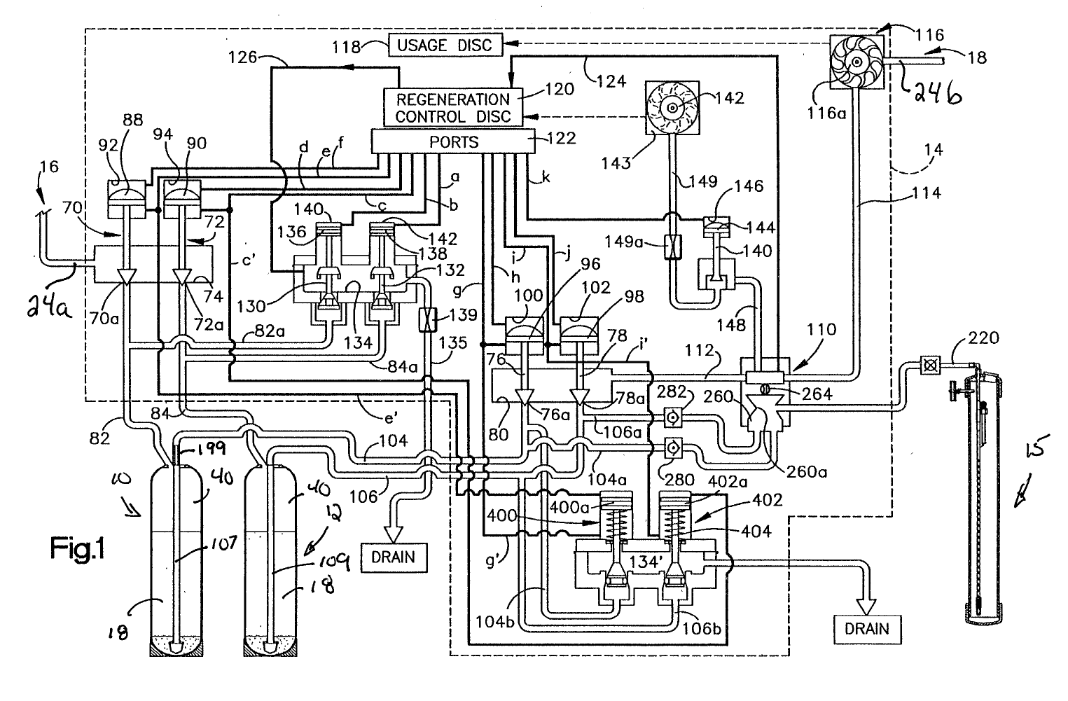

FIG. 1 schematically illustrates a filter system for removing sulfur from water, constructed in accordance with the preferred embodiment of the invention. The system includes a pair of filter tanks 10, 12 interconnected by a control valve module 14 that is similar to the control valves described in U.S. Pat. Nos. 4,298,025; 3,819,552; 4,764,280 and 6,214,214, all of which are hereby incorporated by reference. A regenerant reservoir, indicated generally by the reference character 15 is connected to the valve 14.

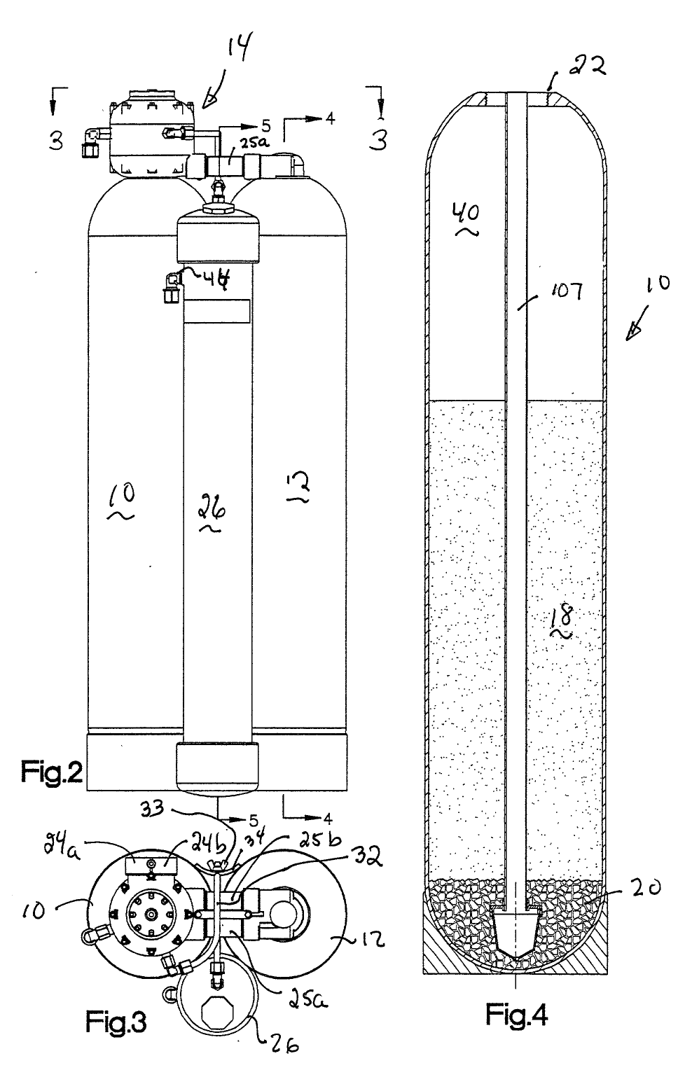

FIGS. 2-7 illustrate a configuration of a filter system represented by the schematic of FIG. 1. The tanks 10, 12, as seen in FIG. 4, are elongate in construction and contain a filter media 18 situated above a bed of gravel 20. A riser tube 107 having a lower end positioned in the gravel bed extends through the center of the tank terminating near a threaded tank port 22. A portion of the tank port 22 defines an inlet to the tank that in effect surrounds the riser tube when the control valve 14 is attached to the tank 10. The control valve 14 interconnects tanks 10, 12 and includes structure that connects to the threaded opening 22 and the riser tube 21 to define isolated inlet and outlet flow paths.

The control valve 14 includes inlet and outlet ports 24a, 24b and interconnecting inlet/outlet conduits 25a, 25b. A regenerant tank 26 is held to the filter tanks by suitable hardware, such as a bolt, associated wing nut and clamping plate 32-34. A restrictor 199 (shown in FIG. 1 only) reduces the flow rate in tank 10 to compensate for flow losses in the tank 12 and interconnecting conduits 25a, 25b so that the flow rates in the tanks 10, 12 are substantially equal.

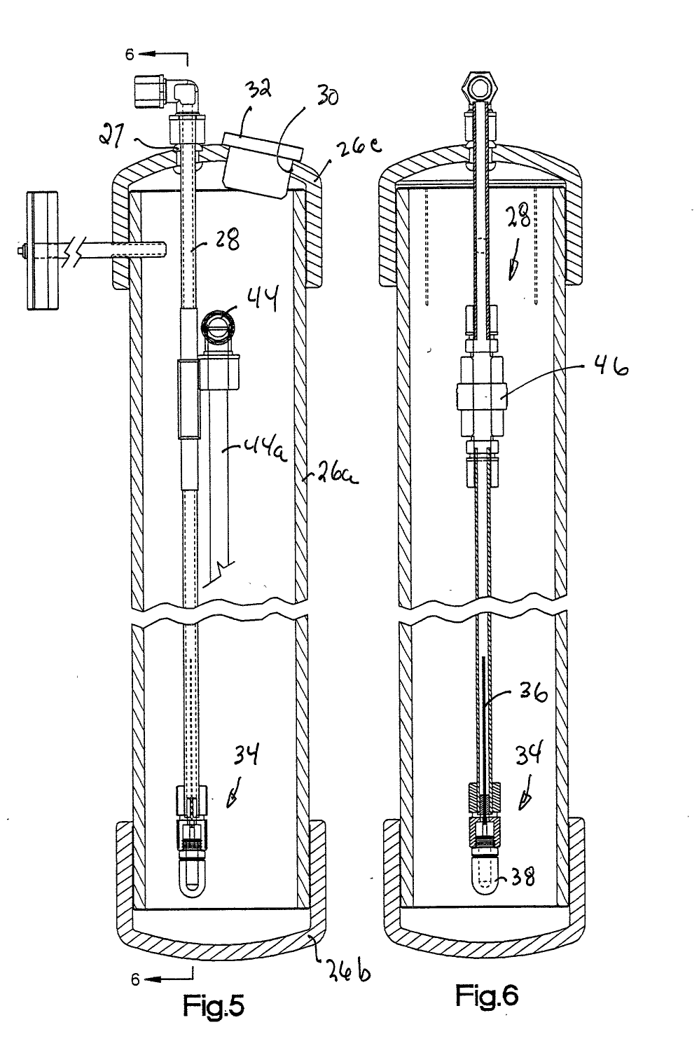

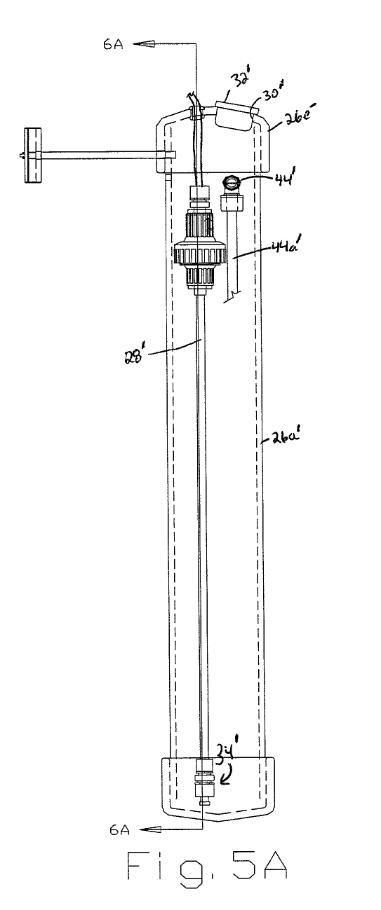

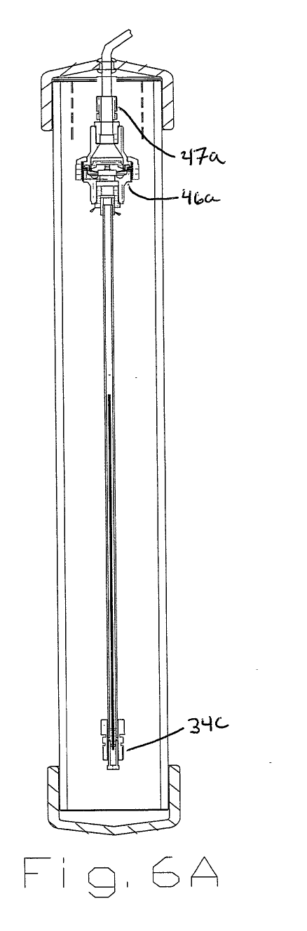

According to the invention, the regenerant tank 26 (referring to FIGS. 5 and 6) includes a cylindrical shell 26a, a bottom end cap 26b and an upper end cap 26c. The upper end cap 26b includes a grommetted hole 27 through which a regenerant draw tube assembly 28 extends. A fill port 30, capped by a suitable plug 32 is also defined by the upper end cap 26c. The draw tube assembly 28 extends from the upper end cap down through the cylindrical shell 26a and terminates in an inlet fitting 34, near the bottom of the regenerant tank 26. The regenerant tank can take on various configurations and sizes that would be apparent to those skilled in the art.

FIGS. 5A, 6A and 7A illustrate an alternate construction for a regenerant tank 26′. To facilitate the explanation, components shown in FIGS. 5A, 6A and 7A which are substantially similar to those in FIGS. 5, 6 and 7 will be designated by like reference characters followed by an apostrophe.

In the preferred and illustrated embodiment, 5.25%-6% sodium hypochlorite is preferably used as a regenerant and is poured into the regenerant tank 26 through the fill port 30.

This regenerant is readily available from many sources and is generally sold as standard household bleach.

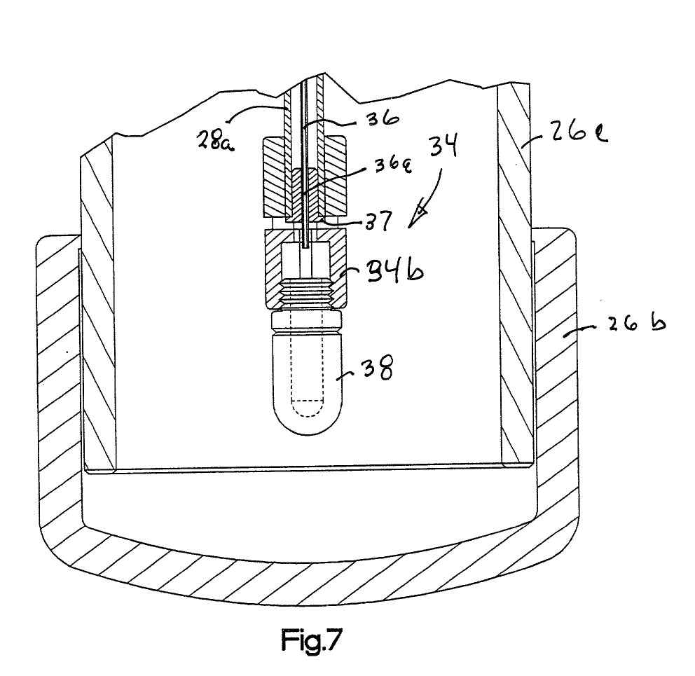

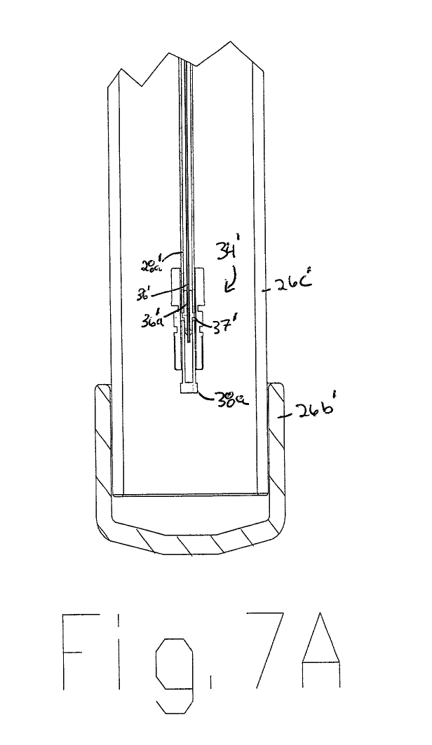

Referring, in particular, to FIG. 7, the inlet fitting 34 at the lower end of the draw tube assembly 28 includes a flow control element 36 which in the preferred embodiment comprises a capillary tube which restricts the flow of regenerant, i.e., bleach into the draw tube assembly 28, during a regeneration cycle.

As seen best in FIG. 7, the inlet fitting 34 is attached to the bottom of a draw conduit 28a which forms part of the draw tube assembly 28. A lower end 36a of the capillary tube 36 is held in position at the end of the draw tube conduit 28a by a collet 37. The collet is potted or otherwise secured to the inside of the draw tube using a suitable sealant. Similarly, the end of the capillary tube 36a is adhesively held in the collet 37 by a conventional sealant. The fitting 34 also includes a female coupling portion 34b which is adapted to receive a replaceable, threaded filter element 38. The filter, which may be of a porous stone material such as used to inject air into an aquariums, prevents particulate from entering and blocking the capillary tube. Alternately, a filter 38a (shown in FIG. 7A) available from Porex Corporation designated as part number 6713 may be used or its equivalent; the filter 38a is coupled to fitting 34 by means of the compression fitting 34c (See FIG. 7A).

As seen best in FIG. 4, the filter media which is preferably catalytic carbon 18, only partially fills the tank, leaving “freeboard” space 40 above the filter media. The “free board” allows the filter bed to be “fluffed” or expanded prior to regeneration in order to maximize contact of the filter material with the regenerant. The gravel bed 20 acts as a distributor or spreader for fluid emitted by the riser tube 21 during regeneration or/and during backwashing.

The regenerant tank 26 also includes an overflow port 44 defined in the cylindrical shell 26a. A suitable overflow tube 44 a is attached to the overflow port and is connected to a suitable drain. The draw tube assembly 28 includes a check valve 46. The purpose of the check valve is to prevent reverse flow in the draw tube assembly. During regeneration, regenerant i.e. bleach is drawn into the control valve 14, as will be explained, through the draw tube assembly 28. The check valve 46 prevents the flow of fluid back into the regenerant tank from the control valve 14. However, should the check valve 46 leak, or any part of the draw tube assembly, the overflow port 44 will convey the excess fluid directly to drain.

Referring in particular to FIG. 1, the control valve assembly 14 controls the communication of a source of water to be treated, indicated generally by the reference character 16 with the filter tanks 10, 12; the communication of the tanks with an outlet indicated by the reference character 18; and, the regeneration of an exhausted tank.

The valve assembly 14 includes a plurality of water pressure operated valves, the opening and closing of which are controlled by a fluid signal control system. Whether the tanks 10, 12 are on-line or off-line is determined by a pair of inlet valves 70, 72 disposed in an inlet chamber 74 and a pair of outlet valves 76,78 disposed in an outlet chamber 80. The inlet conduit 16 fluidly communicates with the inlet chamber 74. The inlet valves 70, 72 control the communication between the inlet chamber 74 and respective tank inlet passages 82, 84. Opening the valves 70, 72 allows feed water in the inlet conduit 16 to proceed into the tanks 10, 12, respectively.

In normal service, water to be filtered is concurrently communicated to the tanks 10, 12 by simultaneously opening both inlet valves 70, 72.

The valves 70, 72 are operatively connected to a piston 88, 90 disposed in chambers 92, 94, respectively. The application of fluid pressures above the pistons apply valve closing forces to urge the valves 70, 72 into engagement with respective valve seats 70a, 72a. The application of fluid pressure to the underside of the pistons exerts valve opening forces.

The outlet valves 76, 78 are similarly configured and include pistons 96, 98 disposed in chambers 100, 102. The application of fluid pressure above and below the pistons 96, 98 applies valve closing and opening forces, respectively for moving the valves 76,78 towards and away from associated valve seats 76a, 78a.

The valves 76, 78 control the communication between tank outlet passages 104, 106 of the tanks 10, 12, respectively with the outlet chamber 80. The outlet passages 104, 106 are connected to the top of the tanks 10, 12 and are in fluid communication with respective risers 107, 109. The risers extend downwardly from the top of the tanks and open near the bottom of the respective tanks. In normal service, water to be treated is introduced at the tops of the tank by an associated inlet passage 82, 84. The water travels downwardly through a treatment media located in the tank and is discharged from the tank by way of the associated riser. In short, the treated water leaves from the bottom of the tanks 10, 12 and travels upwardly through the riser tubes 107, 109 and into the respective outlet passages 104, 106.

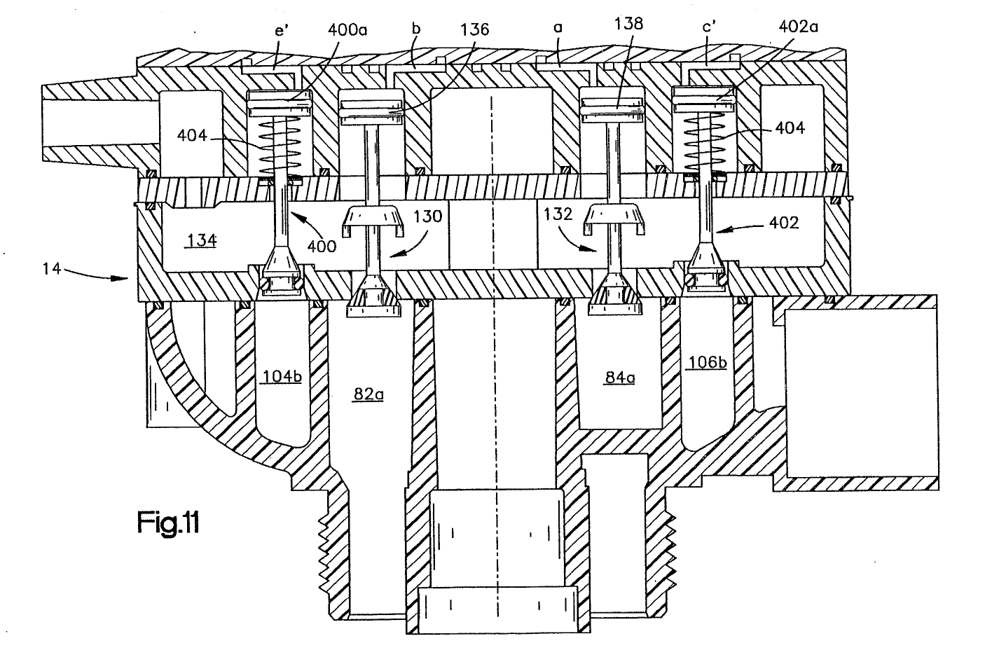

When either of the valves are open, water flow from the associated tank is allowed to proceed to a water collection chamber 110 by way of a passage 112. The collection chamber 110 communicates with the outlet conduit 18 through a fluid path that includes a passage 114 and an outlet chamber 116 that includes a rotatable turbine 116 a. As fully described in U.S. Pat. Nos. 3,891,552 and 4,298,025, the turbine is mechanically coupled to a usage monitoring disk 118 (shown in FIG. 10) which rotates as a function of the amount of water discharged through the outlet chamber 116 into the outlet conduit 18.

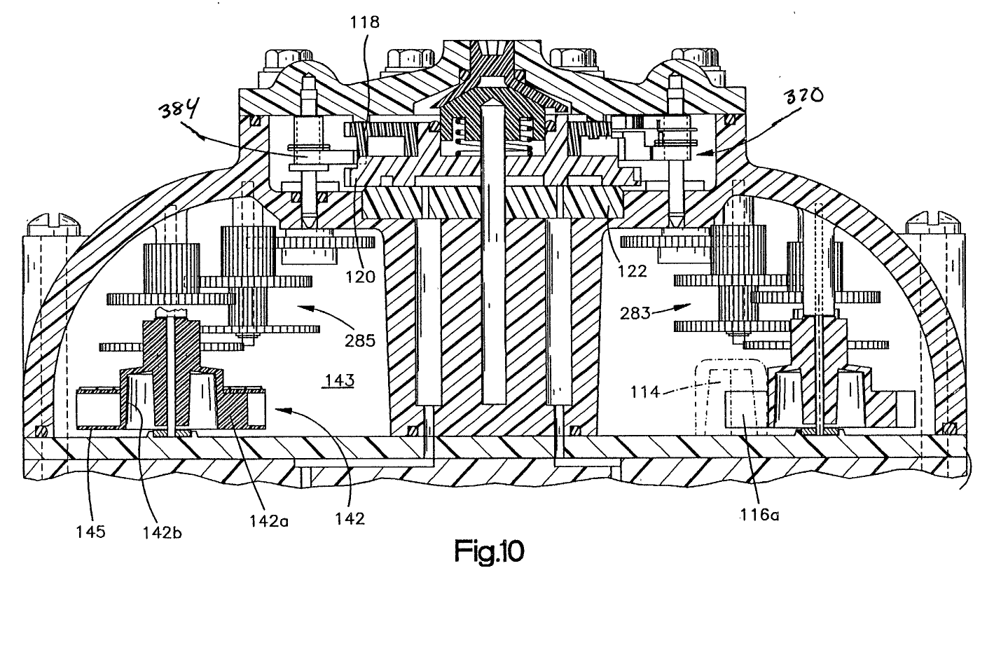

Referring also to FIGS. 1, 8, 9 and 10, the usage monitoring disk 118 cooperates with a regeneration control disk 120. The control disk rotates atop an annular insert 122 (shown in FIG. 9 and 10) that defines a plurality of ports each communicating with an associated signal line. Signal lines a-k are illustrated in FIG. 1. Each line extends from the port insert 122 to one of a plurality of piston chambers. The control disk 120 sealingly engages the top surface of the insert 122 and includes structural formations that operate to communicate the ports formed in the insert 122 with either water supply pressure (supplied by a passage 124) or ambient pressure (by communicating the ports with one of two drain passages 126a, shown in FIG. 9 only). In FIG. 1, the drain passages 126 a are represented by a single drain line designated as 126. The ports and regeneration control disk 120 are arranged so that as the regeneration wheel 120 rotates, the valves are sequentially operated in order to cycle an exhausted tank through a regeneration cycle.

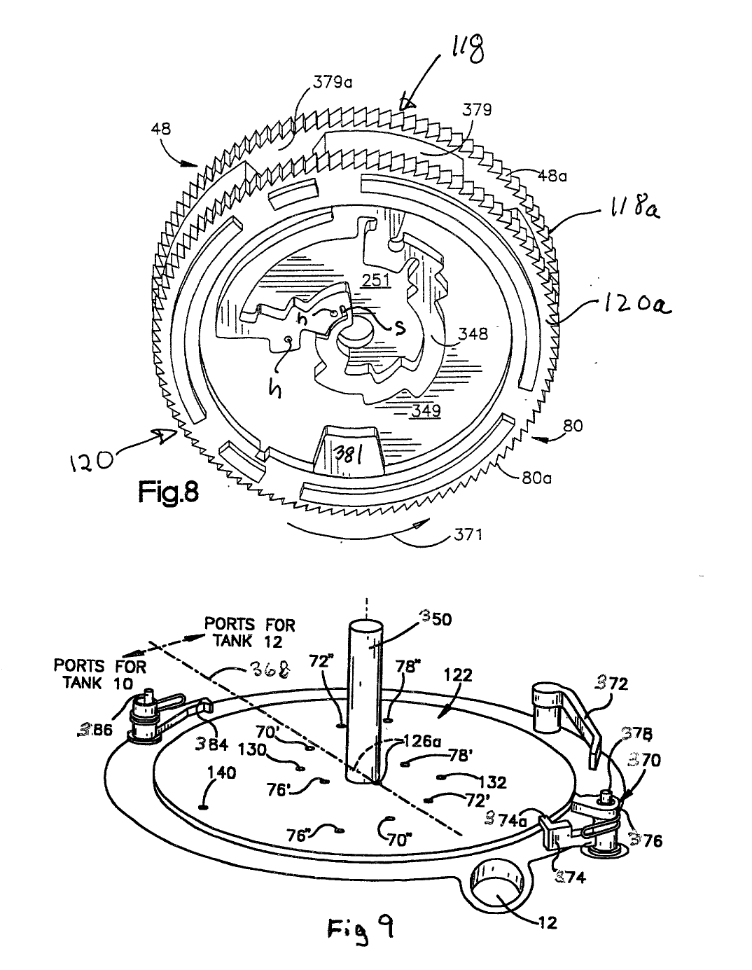

The holes h (see FIG. 8)in the control disk 120 passes through to the vented or ambient air area on top of the control disk. This allows the ports in the port disk 122 (FIG. 9) to vent at the appropriate time. The slot s (FIG. 8)in the control disk 120 transfers a pressure source to the appropriate area of the land area 348 to pressurize the appropriate port in the ceramic disk 122.

In addition to the valve elements described above, the control valve assembly 14 also includes a pair of drain valves 130, 132 for controlling the communication of the tank inlet passages 82, 84, respectively, with a drain chamber 134 through respective branch passages 82a, 84a. The drain chamber 134 communicates with ambient pressure drain through a drain conduit 135.

The drain valves 130, 132 are operated by pistons 136, 138 disposed in respective piston chambers 140, 142. In the preferred embodiment, the pistons are single acting and are driven to a valve open position by the application of fluid pressure to their top surfaces via signal lines a, b. When the fluid signals applied to the top piston surfaces is terminated, the drain valves 130, 132 are returned to their closed positions by a biasing force generated on the underside of the pistons by back pressure developed in the drain chamber 134. The back pressure in the drain chamber 134 is developed due to a flow restrictor 139 disposed in the drain conduit. As the drain valves near their closed positions, fluid pressure in the conduits 82a, 84a apply additional force to the valve heads tending to fully close the valves and maintain their closure. In an alternate embodiment, biasing springs (not shown) bias the valves towards their closed positions illustrated in FIG. 1 when the associated signal lines a, b are depressurized.

A regeneration control valve 140 controls the communication of water pressure from the water collection chamber 110 to a regeneration control turbine 142 located in a turbine chamber 143. The valve 140 includes a single acting piston 144 disposed in a chamber 146. The valve 140 is biased to its closed position by back pressure generated by a flow restrictor 149 a disposed in a delivery passage 149 which controls the flow rate of water from the collection chamber 110 communicated through a passage 148, when the valve 140 is opened. When the regeneration control valve 140 is opened (by the application of a fluid signal to the top surface of the piston by way of the signal line k) water pressure is allowed to proceed from the passage 148 to the passage 149 which includes a nozzle (not shown) for directing water against the turbine 142. The turbine 142 is mechanically coupled to the regeneration control disk 120 so that rotation of the turbine effects rotation of the control disk. The water used to drive the turbine 142, is ultimately discharged to drain.

The application of fluid signals to the various piston chambers, as controlled by the relative movement of the regeneration control disk with respect to the port insert 122, determines the sequence of valve actuation. The control disk 120 selectively communicates either water pressure from the collection chamber (fed to the disk by the pressure line 124) or the ambient drain pressure via the passage 126 (which communicates with the drain ports 126a shown in FIG. 9), to the various signal lines.

The regeneration components include a regeneration fluid aspirator 260 disposed in the collection chamber 110. The aspirator comprises a fluid flow regulating element 264 and a venturi 260a. The outlet of the venturi communicates with the tank outlet passages 104, 106 through branch passages 104a, 106a that include check valves 280, 282. The throat of the venturi communicates with the source of regeneration solution 15.

When either of the drain valves 130, 132 are opened (and the respective inlet and outlet valves are both closed), water in the collection chamber 110 is allowed to proceed through the venturi 260a and into the tank being regenerated. For example, suppose the drain valve 130 is opened. Water from the collection chamber will flow through the venturi 260a into the outlet passage 104 of the tank 10 (via passage 104a). The water will then travel through the tank assembly 10 in a counterflow direction and be ultimately discharged to the ambient drain by way of the inlet passage 82, the branch passage 82a and the drain chamber 134. As water passes through the venturi, regeneration fluid is drawn from the regeneration source 15 through a supply conduit 220 and mixed or “aspirated” with the venturi fluid. The regeneration fluid (now diluted with treated water) passes through the tank being regenerated. The effluent from the tank is discharged to drain via the drain chamber 134.

In the illustrated embodiment, the filter media 18 preferably comprises catalytic carbon. It has been found that a 20×50 mesh Centaur Carbon which is available from Calgon Carbon Corporation may be used as a filter media. The capillary tube 36 in the illustrated embodiment is available from Zeus Industrial Products under the designation “2E030010 TFE SPEC NATURAL”. In the preferred embodiment, the capillary tube provides a bleach flow rate during the drawing step in the range of 30-50 milliliters per minute. More preferably, the flow rate is approximately 40 milliliters per minute. A venturi with an appropriate sized throat opening is selected so that a draw of 30 to 50 milliliters per minute of bleach will provide the carbon bed with a regeneration solution of 1000 to 1500 parts per million of chlorine.

In the disclosed embodiment, the capillary is cut to 22 inches in length and has an inside diameter of 0.030 inches. A capillary tube with an inside diameter of 0.020 cut to a length of 3.125 inches may also be used. However, the larger diameter capillary tube is preferable because it is less likely to get plugged by foreign particles. In addition, when cutting a capillary tube to a 22 inch length, a small cutting error will have less of an effect on the draw rate through the capillary tube as would be the case with a shorter length of tube.

It has been found that for the disclosed system a total regeneration time in the range of 25 to 29 minutes will require a capillary of 22 inches in length. However, due to water chemistry in some parts of the country and the harsh elements of outside applications (high temperatures and ultraviolet levels) an alternative regeneration time range of 35 to 40 minutes may be desired. In such an application a capillary length of 18 inches would be preferred. Such conditions have also prompted the development of an alternative check valve 46a (shown in FIG. 6A). This check valve can be obtained from Ryan Herco Products Corporation in Broklyn Heights, Ohio and is manufactured by Plast-O-Matic Corporation with the part description of a viton diaphram check valve part number 1021-viton. Also the fittings 34c and 47a are selected from a chlorine resistant material preferably Kynar, which is a proven chlorine resistant material.

The sequence of regeneration steps as well as the frequency of regeneration is controlled by the regeneration control disk 120 and the usage disk 118, respectively. Referring to FIGS. 1, 8 and 9, the regeneration control disk 120 sealingly engages and rotates atop the circular port-defining insert 122. The ports defined by the insert 122 communicate with the various piston chambers. The underside of the regeneration control disk 120 includes a depending wall 348 that divides the underside of the disk 120 into pressurized and drain regions 349, 251. The port insert 122 includes a pair of drain apertures 126a located on either side of an upwardly extending stub shaft 350 about which both the regeneration control disk 120 and the water usage disk 118 rotate. The drain apertures 126a communicate with the drain chamber 134 through the passage 126 (shown in FIG. 1) which is integrally formed in the valve body. Thus, the drain region of the regeneration control disk is maintained at the ambient drain pressure.

Two sets of ports are provided in the insert 122 and are located symmetrically about an imaginary diametral line 368. The ports to the left of the line 368 control the regeneration sequence for the tank 10 whereas the ports to the right of the line 368 control the regeneration sequence for the tank 12. During a regeneration cycle, the control disk 120 rotates 180° to effect the complete regeneration cycle of one of the tanks. The location of the ports and their function, as shown in FIG. 9 correspond to the ports shown and described in U.S. Pat. Nos. 3,891,552 and 4,298,025. As fully explained in these earlier patents, the depending wall 348 controls the communication of pressurized water from the pressurized region 349 to the ports or communicates the ports with the drain region 251 to depressurize the respective chambers. The inlet and outlet valves 70, 72, 76 and 78 each include a “top” and a “bottom” port. The “top” ports communicate with the top of the associated operating pistons 88, 90, 96, 98 and the pressurization of these ports apply a valve closing force. Conversely, the “bottom” ports communicate with the underside of the pistons and apply valve opening forces when pressurized.

To facilitate the explanation, the ports shown in FIG. 9 will use the same reference characters as those used for the valves with which they communicate. If a given valve has both an upper and lower port, the upper port will be designated by the same reference character that is used for the valve it controls, followed by a single apostrophe. The bottom port for that valve will be designated by the same reference character followed by a double apostrophe. For valves that only require a single port, i.e., the drain valves 130, 132, the port will be designated by the same reference character that is used for the valve. As an example, the port marked 70′ communicates with the region above the piston 88 of the intake valve 70 via signal line f. The port marked 70″ communicates with the underside of the piston 88 of the valve 70 via signal line e. The port marked 130 communicates with the drain valve 130 via the signal line b.

Usage disk 118 and the regeneration control disk 120 are preferably rotated by a drive mechanism fully disclosed in U.S. Pat. No. 4,298,025. Referring to FIGS. 1, 8, 9 and 10, the disks 118, 120 are driven by a ratcheting mechanism that includes a plurality of pawls. As seen best in FIG. 10, the usage disk 118 rotates atop and concentrically with the regeneration control disk 120. The disks 118, 120 each include peripheral ratchet teeth 118a, 120a respectively, as best shown in FIG. 8. The water usage disk 118 is rotated by a pawl arrangement indicated generally by the reference character 370, shown in FIG. 9. Both discs rotate in the direction indicated by the arrow 371 in FIG. 8; an anti-reverse pawl 372 (shown in FIG. 9) prevents reverse rotation of the disk 118.

FIG. 9 best shows the pawl arrangement 370, which includes a pair of individual, spring biased pawls 374, 376, concentrically journalled on an eccentric shaft 378. The shaft 378 is coupled to the water usage turbine 116a (FIG. 1) through a reduction gear train 283 (shown in FIG. 10). In operation, the usage turbine 116a shown in FIG. 1, and hence the water usage disk 118 rotates in proportion to the amount of treated water discharged by the valve assembly 14.

The usage disk 118 also includes an axially depending flange 379 that is interrupted by a plurality of circumferentially spaced slots 379a (shown in FIG. 8).

The number and position of the slots 379a determine the frequency of regeneration. The lower pawl 374 of the ratchet mechanism 370 includes a prong 374a that extends into sliding engagement with the flange 379. The prong 374a is sized so that when in engagement with the flange, the pawl 374 is maintained out of engagement with the regeneration control disk 120. When the prong 374a enters one of the slots 379a, the pawl 374 engages the ratchet teeth 120a of the regeneration control disk 120 so that rotation of the eccentric shaft 378 causes concurrent rotation in the disks 118, 120. The initial rotation of the regeneration control disk 120 by the lower pawl 374 causes one of the control valve ports in the port insert 122 to be pressurized by virtue of being uncovered by a depending surface 381, thus initiating regeneration.

When the control valve 140 (shown in FIG. 1) is open, a fluid stream is directed to the regeneration turbine 142 (shown in FIG. 1) located in the turbine chamber 143. The turbine 142 is mechanically coupled to a regeneration drive pawl 384 through a reduction gear train 385 (shown in FIG. 10). The pawl 384 is journalled on an eccentric shaft 386. Rotation of the turbine 142 thus effects incremental rotation of the regeneration control disk 120 and in so doing, effects a regeneration cycle. The regeneration cycle continues until the control port communicating with the control valve chamber 146 via signal line K (shown in FIG. 1) is depressurized thus closing the control valve 140.

During the regeneration cycle, treated water is communicated to the venturi 260a. The flow of water through the venturi draws regeneration solution from the regeneration source 15 via conduit 220.

In a water softening application, the regeneration source 15 typically includes a brine well and brine control valve (not shown). When a predetermined amount of regeneration solution is drawn from the source 15, the brine valve (not shown) closes. The flow of treated water (in this example softened water continues to flow into the regenerated tank for a predetermined amount of time to effect a counterflow rinse. After a predetermined amount of time, the flow of softened water into the tank being regenerated is terminated by depressurizing the appropriate drain piston chamber 140, 142.

Referring in particular to FIGS. 1, 8, 9 and 10, the process steps will now be discussed in greater detail. As indicated above, a regeneration cycle is initiated when the depending surface 381 uncovers one of the ports communicating with the control valve 140. As seen in FIG. 9, two control valve ports, separated by 180°, are defined in the insert 122. It should be apparent, the regeneration control disk 120 rotates through an arc of 180° during a regeneration cycle. For purposes of explanation, suppose that tank 10 requires regeneration. As indicated in FIG. 9, the ports, defined in the insert 122, to the left of the diametral line 368, control the regeneration of tank 10. Movement of the regeneration control disk 120 is initiated by the pawl assembly 370 as explained above. The initial movement in the disk 120 by the pawl 270 causes the depending surface 381 to uncover the control valve 140.

The water treatment unit may then go through several process steps to complete the regeneration cycle depending on the application. Initially the regeneration solution is passed through the tank being regenerated in a counter-flow direction. This is followed by a slow rinse which is also in the counter-flow direction. More specifically, in the slow rinse step, treated water (i.e. softened water if the unit is a water softener) from the collection chamber 110 is injected into the outlet of the tank being regenerated, travels down the associated riser tube 107 or 109 and then is discharged through the inlet conduit into the drain chamber. Full details of this step of the regeneration process can be found in U.S. Pat. Nos. 4,298,025 and 3,819,552.

In the treatment of water to remove sulfur (or hydrogen sulfide-H2S), the following steps are preferably performed during the regeneration of a depleted tank. First a back wash is initiated which communicates filtered water from the on-line tank in a countercurrent direction into the tank being regenerated. This step in effect washes out heavy particulate matter. This is followed by a bleach draw which passes regeneration solution through the filter media 18 in a countercurrent direction. A slow rinse is performed concurrently with the draw step, which passes filtered rinse water through the carbon filter bed at a slow flow rate to help pass the regeneration solution through the bed and ultimately discharged to drain. A slow rinse may be performed following the bleach draw to begin rinsing the media of the regeneration solution. However, in the disclosed embodiment the bleach draw is extended such that bleach continues to be drawn into the tank being regenerated during the time that in other applications a slow rinse would be in effect.

The draw (or “slow rinse”)is followed by a back wash which more fully rinses out the regeneration chemicals.

In an illustrated example, a water treatment apparatus having two treatment tanks, containing catalytic carbon and a small bed of gravel, an oxidant solution reservoir containing sodium hypochlorite, 6% by weight, and a control valve that preforms the following regeneration sequence listed in Table 1.

TABLE 1

| | | PERCENTAGE OF |
|---|---|---|
| | REGENERATION | TOTAL |
| | TIME | REGENERATION |
| REGENERATION STEP | (IN SECONDS) | TIME |
| Control Flow (begin) | 54-111 | 2.6%-5.3% |
| Pre-Backwash | 209-258 | 9.9%-12.6% |
| Oxidant Draw | 1179-1181 | 56.1%-57.5% |
| Backwash | 175-186 | 8.5%-8.8% |
| Control Flow | 53-56 | 2.5%-2.5% |
| Downflow Fast Rinse | 180-184 | 8.6%-8.9% |
| Control Flow (end) | 147-184 | 7.2%-8.8% |
| Total Regeneration | 2055-2160 | N/A |

“Control flow” refers to the flow of water past the regeneration turbine which produces the requisite rotation in the regeneration control disc. The times shown in the column next to the references to “control flow” refer to the length of time “control flow” is occurring to produce movement in the disc between successive steps i.e. the time during which the control disc moves from one port(s) to another port(s) in order to initiate a new step. In general, during “control flow” only movement in the regeneration control disc is occurring; the regeneration process is between steps. During this “in between time” the turbine continues to rotate thus driving the regeneration control disk. Actuation of the valves, etc. may also be occurring. Table 1 illustrates the typical ranges used for a regeneration sequence including the time for each step and the percentage that each step is of the total regeneration time.

The disclosed system also includes a full downflow rinse step following the counter-flow (backwash) rinse step. The down flow rinse step conveys water through the regenerated tank in a service direction. This step flushes any remaining regeneratant out of the tank while at the same time tending to pack the bed in preparation for placing the tank in service.

To achieve this step, a pair of purge valves 400, 402 are provided in the control valve 14, fully disclosed in U.S. Pat. No. 6,214,214. The purge valves control the fluid communication between the outlets of the tanks 10, 12 and an ambient drain. More specifically, to effect a downflow rinse of a tank, its associated intake valve is opened, its outlet valve is closed and its associated purge valve is opened. With this valve relationship, source water is communicated to the inlet chamber 74, proceeds into the tank, passes through the water treatment media, and is ultimately discharged from the tank through the associated riser tube. The discharged water is conveyed to drain through an open purge valve associated with the tank.

The logic and hydraulics for opening and closing the purge valves 400, 402 are obtained from fluid signals being sent to the inlet and outlet valves. For purposes of an explanation suppose that tank 12 is the one being regenerated. At the conclusion of the regeneration solution injection step, the tank 12 is rinsed in the counter-flow direction by opening its associated outlet valve 78, opening drain valve 132 while maintaining its associated inlet valve 72 closed. The intake valve is maintained in closed position by the fluid signal communicated to the piston chamber via signal line d. The drain valve is opened by a signal pressure communicated to the drain piston chamber 122 via the signal line a. The associated outlet valve 78 is opened by a signal pressure communicated to the outlet valve chamber by the signal line i.

After a predetermined interval of time, (determined by the rotation rate of the regeneration control disk 120) the downflow rinse step is initiated. To initiate this step, the associated outlet valve 78 is driven to the closed position by a signal pressure communicated to the piston chamber 102 by the signal line j. Concurrently with the application signal pressure via signal line j, the underside of the outlet piston 78 is vented to atmosphere via signal line i. The associated inlet valve 72 is opened by venting the region above the piston 90 to drain via signal line d while concurrently pressurizing the under side of the piston 90 via signal line c. These fluid signals applied to the associated inlet and outlet valves 72, 78 are used to open the associated purge valve 402. In particular, a branch signal line i′ communicates with the under side of the purge valve piston 402a thus venting the underside to atmosphere (since the underside of the outlet piston 78 is also at atmosphere). Concurrently, signal pressure applied to the underside of the inlet valve piston 90 is communicated to the top of the purge valve piston 402a by branch signal line c′. Thus, when the control valve 14 is placed in a state such that the inlet valve i.e. 72 of a tank being regenerated i.e. tank 12 is driven to an opened position while its associated outlet valve i.e. 78 is driven to a closed position, its associated purge valve i.e. 402 is opened.

Referring to FIGS. 1 and 11, with the purge valve 402 of the tank 12 open, source water from the inlet chamber 74 travels into the inlet of tank 12 via conduit 84. This rinse water travels through the treatment media in the tank and is ultimately discharged through the riser 109. The discharged water travels through conduit 106 and travels into the purge valve drain chamber 134′ by way of branch conduit 106b. The water is then discharged to an ambient drain that communicates with the chamber 134′.

At the conclusion of the downflow rinse step, the signal pressure above the purge valve piston i.e. 402a is vented to atmosphere via purge signal line c′ and as a result biasing spring 404 returns the purge valve 402 to the closed position illustrated in FIG. 1.

The downflow fast rinse step for tank 10 is achieved in a similar manner. In the case of tank 10, its associated purge valve 400 is opened and closed by signal pressures communicated from the underside of the associated inlet valve 70 via branch signal e′ and the signal pressure communicated to the underside of the purge piston 400a via branch signal line g′. During the downflow rinse step of tank 10, source water in the inlet chamber 74 is communicated to the tank 10 via the opened inlet valve 70 and the conduit 82. The rinse water travels downwardly through the treatment media and is discharged from the tank via the riser tube 107 and outlet conduit 104. This rinse water is ultimately discharged to an ambient drain via branch outlet passage 104b, the open purge valve 400 and the drain chamber 134′. At the conclusion of the rinse step, a biasing spring 404 recloses the purge valve once the region above the purge valve piston 400a is depressurized.

In the preferred embodiment, the drain chamber 134′, which is shown separately in FIG. 1, actually forms part of the drain chamber 134. This preferred configuration is shown in FIG. 8.

It should be noted that water chemistry differs throughout the country. It has been found that for optimum performance the source or feed water should be iron free and soft. Feed water that contains iron will decrease the amount of hydrogen sulfide that the disclosed system can remove. When hard water comes in contact with bleach, a certain amount of crystallization will occur; such crystallization may prevent proper regeneration, thus causing the unit to be less effective. It is, therefore, preferred that a water softener or other prefiltering system be used to pretreat the feed water prior to treatment by the system of the present invention.

Although the invention has been described with a certain degree of particularity, it should be understood that those skilled in the art can make various changes to it without departing from the spirit or scope as hereinafter claimed.

We claim:

1. A method for treating water comprising the steps of:
a) providing at least two treatment tanks, each tank defining a water treatment compartment containing water treatment material including carbon;
b) communicating a source of water to be treated with at least one of said treatment tanks;
c) passing said water to be treated through said one treatment tank;
d) determining when said one tank requires regeneration;
e) upon determining that said one tank requires regeneration, terminating said communication of said source with said one tank and effecting regeneration of said one tank, said regeneration including the step of passing an oxidant solution through said one treatment tank, said oxidant solution being drawn from a reservoir.

2. The method of claim 1, wherein said step of determining when said one tank requires regeneration comprises the step of monitoring the quantity of water passed through said one treatment tank.

3. The method of claim 1, wherein said carbon comprises catalytic carbon.

4. The method of claim 1, wherein said step of passing said oxidant solution through said one treatment tank occurs in a counterflow direction for a predetermined time.

5. The method of claim 1, wherein said regeneration further includes the steps of:
a) the terminating the flow of oxidant solution from said reservoir; and,
b) passing water through said treatment tank in a counterflow direction for a predetermined time sufficient to flush said treatment tank of said oxidant solution.

6. The method of claim 3, further comprising the step of passing water through said treatment tank in a counterflow direction for a predetermined time, prior to initiation of said regeneration in order to fluff the catalytic carbon prior to regeneration.

7. The method of claim 1, wherein said oxidant solution is a bleach solution.

8. The method of claim 1, wherein said oxidant solution is a hydrogen peroxide solution.

9. The method of claim 7, wherein said bleach solution is in the range of about 2% to about 15% sodium hypochlorite.

10. The method of claim 8, wherein said hydrogen peroxide solution contains hydrogen peroxide in the range of about 2% to about 35%.

11. The method of claim 1, further comprising the step of communicating said source of water to be treated with said other tank during regeneration of said one tank.

12. A method for treating water comprising the steps of:
a) providing at least one treatment tank having a water treatment compartment containing water treatment material including carbon;
b) communicating a source of water to be treated with said tank;
c) passing said water to be treated through said treatment tank in order to remove a substance from said water;
d) determining when said tank requires regeneration; and,
e) upon determining that said tank requires regeneration, terminating said communication of said source with said tank and effecting regeneration of said one tank, said regeneration including the step of passing an oxidant solution through said treatment tank, said oxidant solution being drawn from a reservoir.

13. The method of claim 12, further comprising the step of providing another treatment tank and communicating source water to said other treatment tank when said one tank is being regenerated.

14. A method for treating water, comprising the steps of:
a) providing at least two treatment tanks, each tank defining a water treatment compartment containing water treatment material including a carbon bed;
b) communicating a source of water to be treated with at least one of said treatment tanks, while isolating the other treatment tank from said source of water to be treated;
c) passing said water to be treated through said one treatment tank in a first direction until it is determined that said one treatment tank requires regeneration;
d) upon determining that said one tank requires regeneration, terminating said communication of said source of water with said one tank and communicating said source of water to be treated with said other tank;
e) effecting regeneration of said one tank by:
i) passing water through said one treatment tank in a counterflow direction for a predetermined time in order to fluff said carbon bed;
ii) conveying an oxidant solution from a reservoir to said one tank and passing said solution through said carbon bed in a counterflow direction for a predetermined time;
iii) terminating said flow of oxidant solution and rinsing said one treatment tank by passing water through said carbon bed in a counterflow direction until said oxidant solution is flushed from said carbon bed;
iv) passing water through said carbon bed in said first flow direction for a predetermined time sufficient to compact the bed.

15. A method of removing a substance containing sulfur, from water comprising the steps of:
a) providing at least two treatment tanks, each tank containing a water treatment material including carbon;
b) providing a controller for controlling the communication of source water to be treated with said tanks, said controller controlling when a treatment tank is on-line and when a treatment tank is off-line;
c) providing a reservoir of oxidant solution and a mechanism to control a regeneration of an off-line tank;
d) placing one of said treatment tanks on-line;
e) passing water through said one treatment tank;
f) monitoring water usage and placing said one tank off-line when it is determined that said one tank requires regeneration;
g) regenerating said one tank by drawing said oxidant solution from said reservoir and passing it through said one tank.

16. The method of claim 15, wherein said other tank is on-line when said one tank is being regenerated and the regeneration of said one tank further includes the step of rinsing said one tank by passing treated water discharged by said other tank through said one tank.

17. The method according to claim 16, wherein the drawing of said oxidant solution from said reservoir is achieved using a venturi to which treated water from said other tank is communicated during regeneration of said one tank.

18. The method according to claim 16, wherein the oxidant solution in said reservoir is drawn through a restrictor.

19. A method for removing a substance containing sulfur, from water comprising the steps of:
a) providing a treatment tank containing a treatment bed that includes carbon;
b) providing a controller for controlling the communication of source water to be treated with said tank and for controlling the regeneration of said tank when regeneration is needed;
c) passing water to be treated through said treatment tank in order to remove said substance;
d) monitoring water usage to determine when said tank requires regeneration;
e) providing a reservoir of oxidant solution;
f) terminating the communication of said source water with said tank when it is determined that regeneration of said tank is required;
g) regenerating said tank by drawing oxidant solution from said reservoir and passing it through said tank;
h) rinsing said tank with a rinse water to flush said oxidant solution from said tank.

20. A water treatment apparatus, comprising:
a) at least twowater treatment tanks each defining a fluid flow path including a compartment containing carbon through which water to be treated is passed;
b) a controller for controlling the communication of water to be treated with said tanks;
c) a monitor for determining when an on-line tank needs to be taken off-line and regenerated; and,
d) a regeneration controller including valving for communicating an oxidant solution from a reservoir to an off-line tank.

21. The apparatus of claim 20, wherein said oxidant solution is drawn from said reservoir through a restrictor comprising a capillary tube.

22. The apparatus of claim 21, wherein a check valve is located upstream of said capillary.

23. The apparatus of claim 21, wherein a venturi located upstream of said capillary dilutes the oxidant solution to a predetermined level.

24. The apparatus of claim 21, wherein a filter is located downstream of said capillary.

25. The apparatus of claim 20, further comprising a means for fast rinsing said off-line tank in a service direction, said fast flow rinse means including a differential pressure operated purge valve that is responsive to fluid pressures applied to inlet and outlet valves associated with each water treatment tank.

26. A water treatment apparatus, comprising:
a) a water treatment tank defining a fluid flow path including a compartment containing catalytic carbon through which water to be treated is passed;
b) controller for controlling the communication of water to be treated with said tank;
c) monitoring means for determining when the tank requires regeneration; and,
d) regeneration controller including valving for communicating an oxidant solution from a reservoir to the tank when regeneration is required.

27. The apparatus of claim 26, wherein said oxidant solution is drawn through a restrictor.

28. The apparatus of claim 27, wherein said restrictor comprises a capillary tube.

29. The apparatus of claim 28, wherein a check valve is located upstream of said capillary tube.

30. The apparatus of claim 28, wherein a venturi located upstream of said capillary tube dilutes the oxidant solution to a predetermined level.

31. The apparatus of claim 30, wherein a filter is located downstream of said capillary tube.
